(19) United States
(12) Patent Application Publication
(10) Pub. No.: US 2018/0146065 A1
(43) Pub. Date: May 24, 2018

(54) CONTEXTUAL RECOMMENDATION FOR AN ELECTRONIC PRESENTATION

(71) Applicant: LinkedIn Corporation, Sunnyvale, CA (US)

(72) Inventor: Krishnaram Kenthapadi, Sunnyvale, CA (US)

(21) Appl. No.: 15/359,381

(22) Filed: Nov. 22, 2016

(51) Int. Cl. H04L 29/08; G06Q 10/10

(52) U.S. Cl. CPC H04L 67/306; G06Q 50/01; H04L 67/22; G06Q 10/105

(57) ABSTRACT

A recommendation system provided with an on-line social network system detects that a user is engaged in an editing session with respect to an electronic presentation and determines items representing professionals that have been identified as associated with one or more skills discussed in the electronic presentation. The recommendation system generates a contextual set of references to items representing professionals using an inverted index of skill to person mappings associated with a company identification and a corporate graph associated with the company identification. The nodes in the corporate graph represent persons professionally engaged with a company represented by the company identification.

### TECHNICAL FIELD

This application relates to the technical fields of software and/or hardware technology and, in one example embodiment, to system and method to generate a set of items referencing professionals to be recommended to a user engaged in an editing session with respect to an electronic presentation.

### BACKGROUND

An electronic presentation (e.g., a slideshow produced using presentation software such as PowerPoint or a web-based slide-hosting service such as SlideShare) is a useful means for sharing information with colleagues, associates, and the public at large. The information being shared may include various concepts—scientific, technical, etc. that are being referenced but not discussed in much detail due to the time constraints that limits the amount of information that can be reasonably imparted by a presentation. At times, a user who is in the process of authoring or editing a presentation may benefit from the existing knowledge of others during the editing or authoring session, especially if they could reach out to people who work within the same organization, i.e., to their co-workers or to freelancers associated with the same organization. The user and/or the user's co-workers and freelancers could be members of an on-line social network that represents its members by means of respective member profiles. For the purposes of this description, the phrase “editing session” refers to either editing or authoring session.

An on-line social network is a platform for connecting people in virtual space. An on-line social network may be a web-based platform, such as, e.g., a social networking web site, and may be accessed by a user via a web browser or via a mobile application provided on a mobile phone, a tablet, etc. An on-line social network may be a business-focused social network that is designed specifically for the business community, where registered members establish and document networks of people they know and trust professionally. Each registered member is represented by a member profile. A member profile is represented by one or more web pages, or a structured representation of the member's information in XML (Extensible Markup Language), JSON (Java.Script Object Notation) or similar format. A member's profile web page of a social networking web site may emphasize employment history and professional skills of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to generate a contextual set of items referencing professionals may be implemented;

FIG. 2 is block diagram of a system to generate a contextual set of items referencing professionals, in accordance with one example embodiment;

FIG. 3 is a flowchart illustrating a method to generate a contextual set of items referencing professionals, in accordance with an example embodiment; and

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to generate a contextual set of items referencing professionals that are relevant with respect to skills discussed in an electronic presentation is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

As mentioned above, a user who is in the process of authoring or editing a presentation may benefit from the existing knowledge of others, e.g., professionals, during the editing or authoring of an electronic presentation. It may be beneficial to automatically determine which skills are being referenced in the presentation that is being edited from a computer system associated with a particular company, determine one or more professionals that have been performing work for the company and who are familiar with the skills discussed in the presentation, and display references to such professionals to the editor/author of the presentation, as a recommendation. References to the recommended professionals that may have expertize with one or more skills mentioned in the presentation may be presented as associated with a particular section of the presentation and/or at the beginning or at the end of the presentation. A skill, for the purposes of this description, is an item of information that represents a skill of a member in an on-line social network system and that is stored in a skills database maintained by the on-line social network system. Each skill-related entry in the skills database includes a phrase (e.g., “programming” or “patent prosecution”) that can appear in a member profile maintained by the on-line social network system in one or more designated profile sections, such as, e.g., in the skills and endorsements section of a profile.

For the purposes of this description the phrases “an on-line social networking application” and “an on-line social network system” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, profile recommendations and endorsements for each other and otherwise be in touch via the social network. Members that are connected in this way to a particular member may be referred to as that particular member's connections or as that particular member's network. The profile information of a social network member may include various information such as, e.g., the name of a member, current and previous geographic location of a member, current and previous employment information of a member, information related to education of a member, information about professional accomplishments of a member, publications, patents, etc. As mentioned above, the profile information of a social network member may also include information about the member's professional skills.

In one embodiment, the system to generate a contextual set of items referencing professionals is implemented as a so-called recommendation system that is provided as part of or associated with the on-line social network system. The recommendation system detects that a user is engaged in an editing session with respect to an electronic presentation at a computer system associated with a company. For the purposes of this description, references to “electronic presentation” and “presentation” are to be understood to include any electronic document that can be edited or authored on a computer system. The term “company” is used to indicate any organization that has professionals, or volunteers, or contractors, etc. The recommendation system then determines which skills are being discussed in the presentation (a set of skills), selects member profiles of professionals that have been identified as associated with one or more of these skills. The selected member profiles are referred to as a candidate set of professionals. A profile in the candidate set of professionals represents the associated professional in the on-line social network system. The recommendation system presents to the user references to at least some of those member profiles. For example, the recommendation system may generate additional user interface including a presentation of references to member profiles of professionals that have one or more skills discussed in the presentation with an invitation to contact those professionals. An example additional user interface may include information about a recommended professional, such as, e.g., name, title, phone number and e-mail address, availability, etc.

In one embodiment, the recommendation system is configured to generate a contextual set of recommended professionals that is personalized by taking into account information that can be derived from a member profile that represents the user in the on-line social network system. The information that can be derived from a member profile includes information regarding the skills that the member claims to possess, as well as the member's preferences that could be inferred from the member's past activities in the on-line social network system. For example, the recommendation system configured to generate a contextual personalized set of recommended professionals can determine that a user is represented by a profile in the on-line social network system, identify those skills that the user already has (according to the profile) and generate a set of user skills that includes items corresponding to the values found in the profile representing the user. The recommendation system can then consider only those skills that the user is lacking (according to the user's profile in the on-line social network system) and include in a personalized set of member profiles only those profiles that are associated with the skills that the user is lacking. The set skills that the user is lacking is referred to as a personalized set of skills. The personalized set of skills, can be the same as the set of skills associated with the electronic presentation if the user's profile indicates that the user does not possess any of those skills. If, however, the user's profile indicates that the user possesses one or more of the same skills as those discussed in the electronic presentation, the personalized set of skills would be generated as a subset of the set of skills associated with the presentation. Some example methodologies for generating a set of user skills are described further below.

A set of skills for a user u is notated as E(u). The recommendation system obtains the items to be included in the set of user skills E(u) by examining the skills section of the user's profile. The skills listed in the skills section of the user's profile are included in the set of user skills E(u).

In some embodiment, the recommendation system generates a personalized contextual set of recommended professionals by ranking items in a set of recommended professionals using a so-called personalized importance score calculated for each skill referenced in the presentation. Each skill referenced in the presentation can he assigned a significance score with respect to a user. The significance score assigned to a user u with the skill c is notated as sigscore (c, u). It is a value that indicates familiarity of the user u with the skill c. The significance score sigscore (c, u) for a user u with respect to skill c is a value assigned to a professional/skill pair to indicate the familiarity of the professional v with the skill c.

The significance scores assigned to a user with respect to skills associated with a presentation can be used to generate personalized importance scores for the skills. A personalized importance score that reflects the importance of a skill with respect to the presentation or its section and also reflects the significance score of the skill with respect of the user. If a skill from the set of skills associated with the presentation is not present in the set of user skills, its significance score is considered to be zero. The personalized importance score for a user u with respect to skill c from a presentation section i can be calculated using Equation (1) shown below.

personalizedimpscore(c, i, u)=g(phi(c, i), sigscore(c, u)), Equation (1)

where g (.,.) is a function of two variables, monotonically increasing in the first variable and monotonically decreasing in the second variable, such as, e.g., g(x, y)=x/(1+y), or g(x,y)=x|exp(y).

The personalized importance score can then be used to generate respective relevance values for items in the candidate set of professionals and rank the items based on their respective relevance values. The details of generating relevance values are described further below.

Another approach to personalizing the presentation set of professionals by taking into account the skills that the user who is engaged in the editing or authoring session with respect to an electronic presentation already possesses, is to identify and exclude, from the candidate set of professionals, items referencing those professionals that can help only with the skills already familiar to the user. The set of professionals that possess one or more skills from the set of user skills E(u) is notated as L_user(u). The references to professional profiles included in L_user(u), which have been identified by the recommendation system as teaching skills already possessed by the user, are excluded from the candidate set of professionals.

In one embodiment, the recommendation system generates a candidate set of professionals by selecting, from profiles maintained in the on-line social network system, profiles of those professionals of the company that have been identified as associated with one or more of these skills. Then, for each item in the candidate set of professionals, the recommendation system generates a relevance value that reflects how familiar the professional is with a skill discussed in the presentation. The candidate set of professionals that have one or more skills discussed in the presentation section i may be referred to as a candidate set of professionals and notated as V(i). it will be noted that the entire presentation can be treated as one section, in which case the presentation section i corresponds to the entire presentation.

The recommendation system can be configured to generate the relevance values. The items in the candidate set of professionals are then ranked based on the respective associated relevance values, and those professionals that have been assigned the highest relevance values are selected as being most relevant and therefore can be included in the so-called presentation set of professionals. References to professionals included in the presentation set of professionals are recommended to the user of the presentation.

A relevance value may be generated for an item in a set of professionals with respect to an associated skill based on the importance of the skill with respect to the presentation or its section, based on the measure of familiarity of the professional with the skill,as well as based on the availability and proximity of the professional as related to the user who is engaged in the editing session.

Availability of a professional (represented by an item in a set of professionals) can either be explicitly captured using the professional preference indicated in a profile representing the professional, or implicitly inferred based on how often the professional responded to recent requests by other users. The proximity of a professional as related to the user who is engaged in the editing session can be captured based on the organizational hierarchy of the company, and other corporate graph information. For example, the proximity can be computed as a function of the following factors: tree distance between respective nodes representing the professional and the user in a corporate graph representing the organizational hierarchy of the company. The proximity can also he calculated by taking into account any discussion groups that are common to the professional and the user, extent of communication (e.g., email, instant messaging, etc.) between the professional and the user, as well as the extent of co-viewership and/or co-authorship of corporate documents by the professional and the user.

A relevance value may he generated for an item in a set of professionals with respect to skills discussed in the entire presentation or with respect to skills discussed in a section of a presentation, e.g., for skills discussed in a particular slide in an electronic slideshow presentation. In some embodiments, the recommendation system generates, for an item in a set of professionals, separate relevance values for separate sections of a presentation and then aggregates those separate relevance values to generate the final relevance value for the item in a set of professionals, which is to he treated as indicating relevance of the item in a set of professionals to skills discussed in the entire presentation.

Equation (2) below is an example of calculating the relevance value of a professional v with respect to all combined sections i in a presentation D.

$$relscore ( v ) = {\sum }_{i ∈ D} relscore ( v , i ) \times significance ( i ) \qquad Equation ( 2 )$$

where different sections i in a presentation D are assigned different significance values significance (i). A significance value for a section in a presentation may be assigned based on various predetermined criteria, such as, e.g., the positioning of a section within the document, the hierarchy of the presentation, etc. Some example methodologies for calculating relevance value for a professional with respect to a section in a presentation are described below.

In one embodiment, in order to generate relevance value for a professional with respect to a section in a presentation the recommendation system first selects a set of most important skills discussed in a presentation section. The skills detected in a presentation section may be identified as most important skills based on their respective importance scores. The importance score for a skill c in a presentation section i may be notated as impscore (c, i) and may be determined using any of the approaches described further below. The recommendation system maintains or has access to an inverted index of skill to person mappings, where, for a professional v (who can be a freelance professional) and a skill c, a mapping entry in the inverted index is in the form of:

skill (c)→List of (professional (v), significance score sigscore (c, v)),

where the significance score is a value assigned to a professional/skill pair to indicate the familiarity of the professional v with the skill c. The inverted index of skill to person mappings can be ordered by decreasing significance scores.

The significance score for a professional/skill pair may be determined by constructing a professional skills graph for a professional, based on the member profile representing the professional in the on-line social network system, with nodes representing respective skills of the subject professional. The recommendation system then applies a graph analysis algorithm, such as, e.g., PageRank, to generate the centrality score for each skill c that is present in the member profile representing the professional v. The centrality score for a skill c with respect to a professional v is notated as phi (c, v). The centrality score phi (c, v) can be used as the significance score. In some embodiments, the significance score sigscore (c, v) can be calculated using the centrality score phi (c, v) together with a so-called endorsement score, which is notated as endlscore (c, v). The endorsement score for a skill c with respect to a professional v can be calculated based on the number of endorsements for the skill c and also based on data reflecting how authoritative the associated endorsers are. The authoritativeness of an endorser may be determined by constructing a connectedness graph for the professional, where the nodes represent the professional and the professional's connections in the on-line social network system, and using a graph analysis technique to determine the importance/authoritativeness of any given node. The significance score of a professional v in the candidate set of professionals V(i) corresponding to the skills search query for the section i can be calculated using Equation (3) shown below.

sigscore(c, v)=f(phi(c, v), endscore(c, v)), Equation (3)

wheref is a monotonically increasing function of two variables, such as, e.g., f(x,y)=xy, or f(x,y)=x·exp(y).

The significance scores calculated for professionals with respect to skills are normalized across all professionals from the candidate set of professionals.

Returning to the discussion of generating the relevance value for a professional with respect to a section in a presentation, after having identified the skills that are being discussed in or that are associated with a presentation section, the recommendation system forms a search query consisting of the most important skills in the presentation section i and queries the inverted index of skill to person mappings. Based on the result of the query, the recommendation system generates the candidate set V(i) of professionals corresponding to the skills search query for the section i. The recommendation system then performs aggregation of the skill-professional significance scores sigscore (c, v) and section-skill importance scores impscore (c, i) in order to rank the retrieved professionals. The relevance value for a professional v in the candidate set V(i) of professionals corresponding to the skills search query for the section i can be calculated using Equation (4) shown below.

relscore(v, i)=h({((impscore(c, i), sigscore (c, v))|c∈C(i)}), Equation (4)

where h is an aggregation function. For example, re/score (v, i) can be calculated as the sum of products of the importance score of a skill c with respect to the section i, impscore (c, i), and the significance score for a professional v with respect to skill c, sigscore (c, v), for all skills c in the set of skills C(i), using Equation (5) below.

$$relscore ( v , i ) = {\sum }_{c ∈ C} impscore ( c , i ) \times sigscore ( c , v ) \qquad Equation ( 5 )$$

In some embodiments, the significance score for a professional v with respect to skill c, sigscore (c, v), is binary; that is, it indicated that the professional either possesses a certain skill or not. In this scenario, the relevance value for a professional is generated based on the combined importance of all skills that are associated with the professional in the inverted index of skill to person mappings.

In some embodiments, the importance score of a skill c with respect to the section 1, impscore (c, , is binary; that is, a skill is associated with (discussed or referenced in) the section i, or not. In this scenario, the relevance value for a professional v is generated based on the significance scores sigscore (c, v) associated with those skills that have been identified as most important for section i in the presentation and possessed the professional.

In some embodiments, the significance score for a professional v for imparting the skill c, sigscore (c, v), is not used. In this scenario, if the skills in the inverted index of skill to person mappings are ordered by decreasing significance scores sigscore (c, v), the recommendation system could use the ordering in the inverted index to rank the professionals. In this case, the professionals could be ranked by rank aggregation across the important skills, for example, using Borda Count method.

As mentioned above, the recommendation system selects a so-called presentation set of professionals based on the respective relevance values generated for the professionals in the candidate set of professionals. For example, the presentation set of professionals may include a certain number professionals that have the top ranks with respect to the section in the presentation. In another example, the presentation set of professionals includes those professionals from the candidate set that have relevance values greater or equal to a predetermined threshold. References from the set of professionals presentation set of professionals are exposed to the user at the time the user is viewing the associated section of the presentation.

in some embodiments, the recommendation system may be configured to generate contextual professional recommendations: as the user transitions from one presentation section to another, the associated presentation set of professional recommendations is generated or accessed, where the professionals to be recommended as relevant to the currently viewed section of the presentation are determined using one of the methodologies discussed above. The recommendation system may also be configured to detect if the user interacted with the presented reference to a recommended professional (e.g., if the user clicked on the professional recommendation) and to omit presentation of a reference to that professional in any of the subsequently presented sections.

As explained above, the recommendation system, in the process of determining the relevance of a professional with respect to a presentation or with respect to a section of a presentation, may utilize the importance value of a skill c with respect to a presentation section i. This importance value notated above as impscore (c. i). Some example methodologies for generating the importance score of a skill with respect to a presentation section are described below.

In one embodiment, a so-called skills detector system may be used to determine which skills are referenced in an electronic presentation and to also generate respective importance scores of the determined skills as related to the presentation. The skills detector system is provided as part of or associated with the on-line social network system. The skills detector system is configured to determine which skills referenced in the presentation and may also be configured also determine respective importance scores of the determined skills as related to the presentation. In order to identify a phrase that appears in a presentation as representing a skill, the skills detector system determines whether the phrase is included in the skills database maintained by the on-line social network system. Respective importance scores of the determined skills may be generated as described below.

The skills detector system, according to some embodiments, is configured to construct a skills graph for a presentation, with nodes representing respective skills and edges being assigned a weight value that represent the degree of relatedness of the respective two skills represented by the two connecting nodes. For example, the two skills “patent prosecution” and “patent drafting” have a greater degree of relatedness than, e.g., the two skills “patent prosecution” and “landscape design.” The skills detector system may be configured to assign a value between “0” and “1” to an edge in a skills graph, e.g., with the greater value assigned to an edge indicating the greater degree of relatedness of the respective two skills represented by the two connecting nodes. Each section of a presentation is thus represented as part of a skills graph. A section in a presentation may correspond to a slide (as in a PowerPoint or a SlideShare presentation), or to a portion of a document included in a chapter or under a headings.

Where the skills detector system generates a skills graph for a presentation, it can calculate a so-called centrality score for each node of the skills graph (and thus for each detected skill). Respective centrality scores for the nodes in the skills graph may be determined by applying a graph analysis algorithm, such as, e.g., PageRank. The centrality score for a skill c in a presentation section i is notated as alpha (c, i).

The skills detector system also associates each skill detected in a presentation with a so-called document structure score, which can be determined by examining the structure in the presentation. For example, a skill represented by a phrase that occurs in the title of the presentation is assigned a larger document structure score than a skill identified by a phrase that occurs only in the body of the presentation. As another example, a skill represented by a phrase that is found under one of the top-level bullets is assigned a higher document structure score than a phrase representing a skill is found under one of the lower-level bullets. The document structure score for a skill c in a presentation section i is notated as beta (c, i).

Where the skills detector system generates a skills graph and, for each detected skill generated a respective document structure score, the importance score for a skill c in a presentation section i is calculated based on the associated centrality score alpha (c, i) and the associated document structure score beta (c, i), using Equation (6) below. Thus calculated importance score is notated as gamma (c, i).

gamma(c, i)=f(alpha(c, i), beta(c, i)), Equation (6)

where f(.,.) is a monotonically increasing function of two variables, such as, e.g., f(x,y)−xy, or f(x,y)−x·exp(y).

In some embodiments, the skills detector system is configured to represent each section in a presentation as a feature vector in high-dimensional space. Some examples of dimensions, in addition to the skill dimension, are title, level in the document structure hierarchy, emphasis in the text presentation (e.g., whether the phrase representing a skill is highlighted, bold, italicized, etc.), occurrence of the skill in previous sections, and occurrence of the skill in subsequent sections. The skills detector system utilizes machine learning techniques to learn a statistical model for calculating the predicted importance score delta (c, i) for a skill c in a presentation section i. The learned model takes, as input, a matrix with skills detected in the presentation section i as rows and features related to the document section (e.g., title, level, emphasis) as columns. The ground truth consists of sections together with the labeled set of important skills.

in some embodiments, the approaches described above for calculating the importance score for a skill c in a presentation section i as lamhda(c,i)=g (gamma (c, i), delta (c, i)), where g(.,.) is a function of two variables, such as, e.g. a convex combination, g(x, y)=rx+(1−r) y, where r is a predetermined coefficient expressing respective weights to be assigned to x and y.

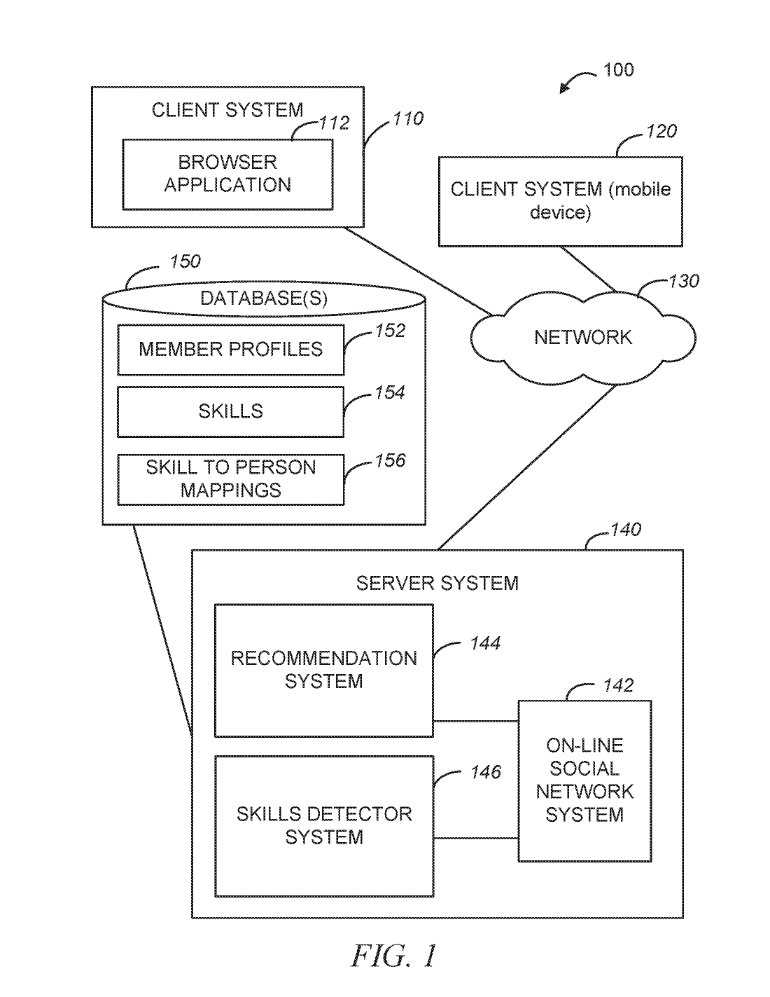

In some embodiments, the skills detector system is configured to select from the detected skills a set of most important skills in a section i, C(i) along with their corresponding importance scores calculated using one of the methodologies described above, and present it to the user. For example, the skills detector system may determine that a certain section in a subject presentation discusses two skills—“grant writing” and “proofreading”—and calculate respective importance scores for each of these skills. When that section of the subject presentation is being viewed by a user, the user can also be presented with the information regarding the skills being discussed in the section, their respective importance scores and an explanation of the importance scores (e.g., explaining that the importance scores were calculated based on the placement of the corresponding phrases within the document structure). Once the skills detector system determines the skills in each section of the presentation and their respective importance scores, this information may be stored as associated with the presentation and used, by the recommendation system to recommend one or more educational programs or on-line professionals that are relevant to one or more of these associated skills. An example recommendation system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data).

As shown in FIG. 1, the server system 140 also hosts a recommendation system 144 that is configured to have one or more functionalities described above. The recommendation system 144 is configured to detect that a user is engaged in an editing session with respect to an electronic presentation at a computer system associated with a company and determine a set of skills that is discussed in the presentation. The recommendation system 144 uses an inverted index of skill to person mappings 156 stored in the database 150, and the determined set of skills to select identifications of those professionals that have been identified as associated with one or more skills from the determined set of skills in the inverted index of skill to person mappings 156. The recommendation system 144 generates a contextual set of references to items representing professionals and can also personalize the set by taking into account information derived from a member profile that represents the user in the on-line social network system 142, using any of the personalization methodologies discussed above. References to at least some of the selected identifications of professionals are then recommended to the user of the presentation.

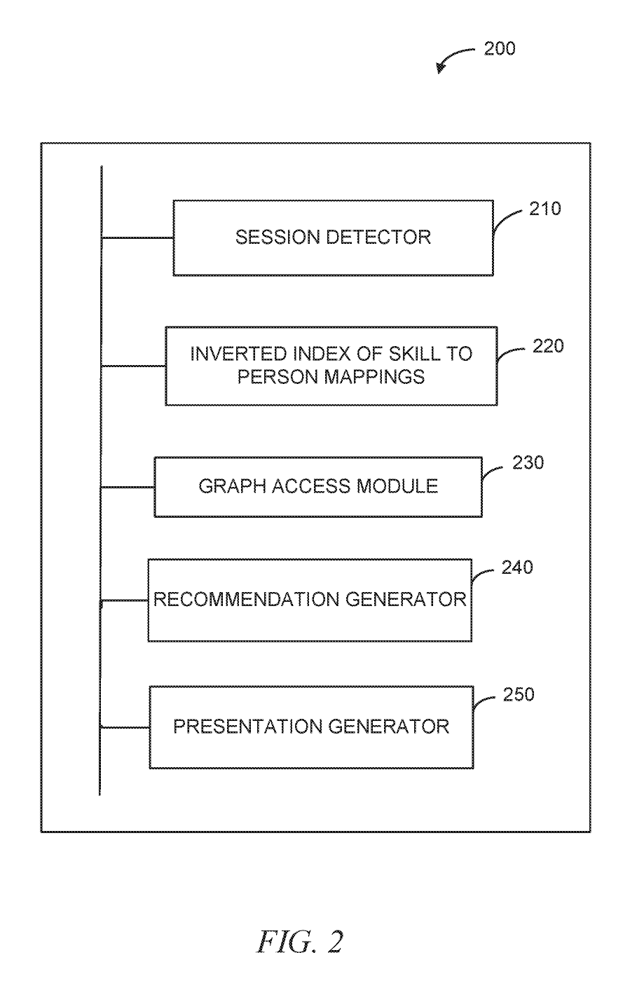

The server system 140 also hosts a skills detector system 146. The skills detector system 146 is configured to determine which skills are referenced in a presentation and generate respective importance scores of the determined skills as related to the presentation. As explained above, in order to identify a phrase that appears in a presentation as representing a skill, the skills detector system 146 determines whether the phrase is included in a skills database 154 maintained by the on-line social network system 142. The skills detector system 144 determines respective importance scores of the determined skills using any of the methodologies described above. An example recommendation system 144 is illustrated in FIG. 2.

FIG. 2 is a block diagram of a system 200 to generate a contextual personalized set of relevant professionals. As shown in FIG. 2, the system 200 includes a session detector 210, an inverted index of skill to person mappings 220, a graph access module 230, a recommendation generator 230, and a presentation generator 250. The session detector 210 is configured to detect an editing session with respect to an electronic presentation, where the editing session is commenced at a computer system associated with a company identification and the electronic presentation associated with a set of skills. In some embodiments, the session detector 210 is also configured to determine that the editing session is associated with a user represented by a member profile in the on-line social network system, and that the member profile includes a set of user skills representing professional skills of the user.

An inverted index of skill to person mappings, which corresponds to the inverted index of skill to person mappings 156 of FIG. 1 is associated with a company identification and is generated and maintained by or accessible by the on-line social network system 142 of FIG. 1. An entry in the inverted index of skill to person mappings comprises a skill mapped to a professional profile representing a professional of a company represented by the company identification in the on-line social network system. The skill corresponds to an entry in the skills database 154 of FIG. 1. The graph access module 230 is configured to access a corporate graph associated with the company identification. Nodes in the corporate graph represent persons professionally engaged with the company, e.g., employees, freelance professionals, etc.

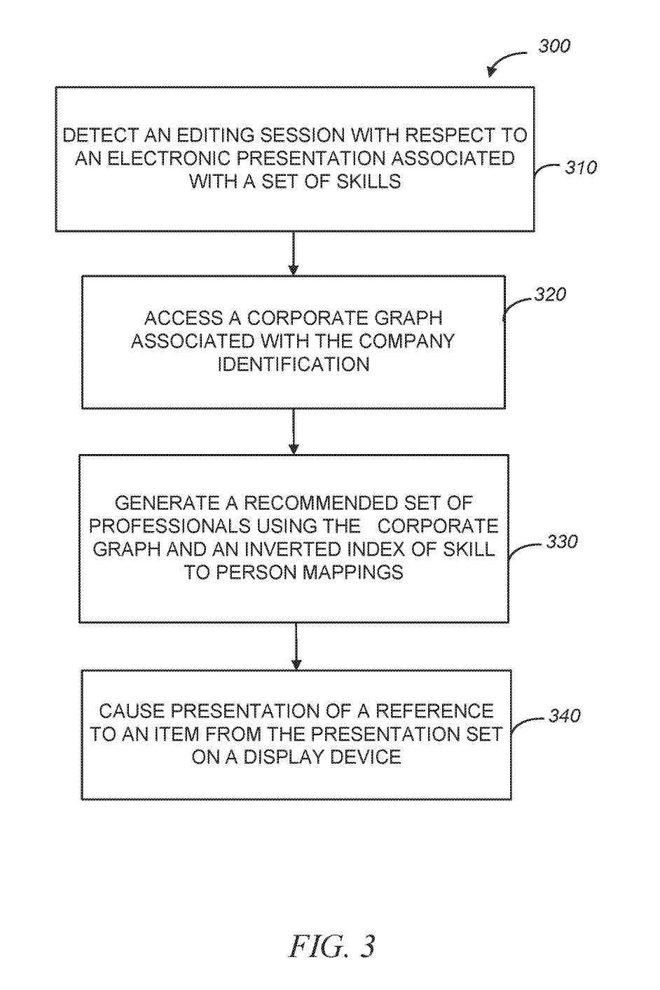

The recommendation generator 240 is configured to generate a recommended set of professionals, each item in the recommended set of professionals comprising a reference to a person represented by a node in the corporate graph and associated with a skill from the inverted index of skill to person mappings 220. The presentation generator 250 is configured to cause presentation, on a display device, of a reference to an item from the recommended set of professionals. As mentioned above, references to the recommended professionals may be presented at the beginning or at the end of the presentation, or as associated with a section on a presentation (e.g., as associated with a particular slide in an electronic slide presentation). In some embodiments, the presentation generator 250 is configured to generate additional user interface including an actionable control associated with the reference to activate a preview of an associated member profile in the on-line social network system 142. Some operations performed by the system 200 may be described with reference to FIG. 3.

FIG. 3 is a flowchart of a method 300 to generate a contextual personalized set of relevant professionals. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the session detector 210 of FIG. 2 detects an editing session with respect to an electronic presentation, where the editing session is commenced at a computer system associated with a company identification and the electronic presentation associated with a set of skills. At operation 320, the graph access module 230 of FIG. 2 accesses a corporate graph associated with the company identification. Nodes in the corporate graph represent persons professionally engaged with the company, e.g., employees, freelance professionals, etc. The recommendation generator 240 of FIG. 2 generates a recommended set of professionals at operation 330. Each item in the recommended set of professionals comprises a reference to a person represented by a node in the corporate graph and is associated with a skill from the inverted index of skill to person mappings 220 of FIG. 2. The presentation generator 250 causes presentation, on a display device, of a reference to an item from the recommended set of professionals at operation 340.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

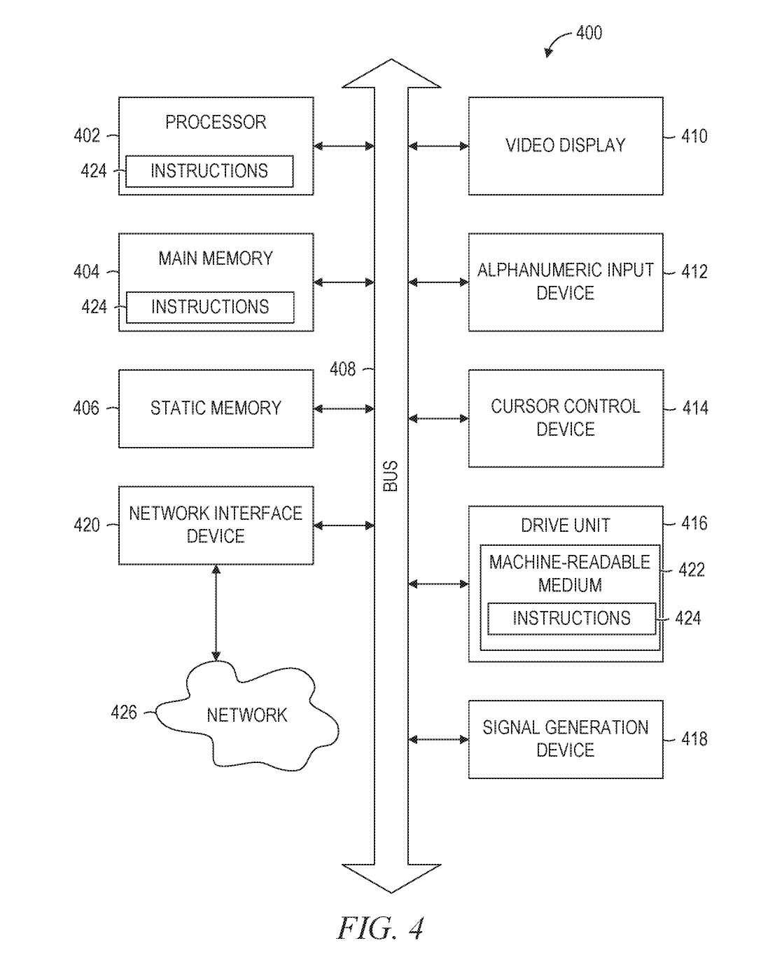

FIG. 4 is a diagrammatic representation of a machine in the example form of a computer system 400 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 404. The computer system 400 may further include a video display unit 410 (e.g., a liquid crystal display (LCD) or a cathode ray tube (CRT)). The computer system 400 also includes an alpha-numeric input device 412 (e.g., a keyboard), a user interface (UI) navigation device 414 (e.g., a cursor control device), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, with the main memory 404 and the processor 402. also constituting machine-readable media.

The software 424 may further be transmitted or received over a network 426 via the network interface device 420 utilizing any one of a number of well-known transfer protocols (e.g., Hyper Text Transfer Protocol (HTTP)).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components snd Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

in various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations, A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g,, configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs),)

Thus, a method and system has been described to generate a contextual personalized set of items representing professionals of a company that possess skills relevant to an electronic presentation. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer implemented method comprising:
detecting an editing session with respect to an electronic presentation, the editing session commenced at a computer system associated with a company identification, the company identification representing a company, the electronic presentation associated with a set of skills;
maintaining an inverted index of skill to person mappings associated with the company identification, an entry in the inverted index of skill to person mappings comprising a skill mapped to a member profile representing, in the on-line social network system, a person professionally engaged with the company, the skill corresponding to an entry in a skills database maintained in the on-line social network system;
accessing a corporate graph associated with the company identification, nodes in the corporate graph representing persons professionally engaged with the company;
using at least one processor, generating a recommended set of professionals, each item in the recommended set of professionals comprising a reference to a person represented by a node in the corporate graph and associated with a skill from the inverted index of skill to person mappings; and
causing presentation, on a display device, of a reference to an item from the recommended set of professionals.

2. The method of claim 1, wherein the recommended set of professionals is a subset of a candidate set of professionals, the method comprising:
generating respective relevance values for items in the candidate set of professionals using respective proximity values, a proximity value for an item in the candidate set of professionals indicating a distance between a node in the corporate graph representing a professional represented by the item and a node in the corporate graph representing the user; and
selecting the recommended set of professionals from the candidate set of professionals based on the respective relevance values.

3. The method of claim 2, wherein the generating of a relevance value from the respective relevance values for an item in the candidate set of professionals comprises using a significance value associated with a pair comprising a member profile identification from the item and a skill from the item.

4. The method of claim 1, comprising determining that the editing session is associated with a user represented by a user member profile in an on-line social network system, the user member profile including a set of user skills, wherein the recommended set of professionals is personalized based on the set of user skills.

5. The method of claim 4, wherein the generating of the recommended set of professionals comprises:
generating a candidate set of skills that includes those entries from the set of skills that are omitted from the set of user skills; and
interrogating the inverted index of skill to person mappings using the candidate set of skills to retrieve items to be included in the recommended set of professionals.

6. The method of claim 4, wherein each skill from the set of user skills is assigned a respective significance score, the generating of the recommended set of professionals comprises:
generating a personalized importance score for each skill in the set of skills using the respective significance scores;
generating a preliminary set of professionals by interrogating he inverted index of employees skills to retrieve items that include a skill from the set of skills;
generating respective relevance values for items in the preliminary set of professionals using the respective significance scores; and
based on the respective relevance values, selecting items from the preliminary set of professionals to be included in the recommended set of professionals.

7. The method of claim 4, wherein the generating of the recommended set of professionals comprises:
generating a user set of professionals by interrogating the inverted index with a set of user skills to retrieve items that include a skill from the set of skills, wherein the recommended set of professionals includes only items that are not present in the user set of professionals.

8. The method of claim 1, wherein the set of skills is associated with a section from a plurality of sections in the electronic presentation.

9. The method of claim 1, wherein the set of skills is associated with the entire electronic presentation.

10. The method of claim 1, comprising generating additional user interface, the additional user interface comprising an actionable control associated with the reference to activate a preview of an associated member profile in the on-line social network system.

11. A computer-implemented system comprising:
a session detector, implemented using at least one processor, to detect an editing session with respect to an electronic presentation, the editing session commenced at a computer system associated with a company identification, the company identification representing a company, the electronic presentation associated with a set of skills;
an inverted index of skill to person mappings, implemented using at least one processor, associated with the company identification, an entry in the inverted index of skill to person mappings comprising a skill mapped to a member profile representing, in the on-line social network system, a person professionally engaged with the company, the skill corresponding to an entry in a skills database maintained in the on-line social network system;
a graph access module, implemented using at least one processor, to access a corporate graph associated with the company identification, nodes in the corporate graph representing persons professionally engaged with the company;
a recommendation generator, implemented using at least one processor, to generate a recommended set of professionals, each item in the recommended set of professionals comprising a reference to a person represented by a node in the corporate graph and associated with a skill from the inverted index of skill to person mappings; and
a presentation generator, implemented using at least one processor, to cause presentation, on a display device, of a reference to an item from the recommended set of professionals.

12. The system of claim 11, wherein the recommended set of professionals is a subset of a candidate set of professionals, the recommendation generator is to:
generate respective relevance values for items in the candidate set of professionals using respective proximity values, a proximity value for an item in the candidate set of professionals indicating a distance between a node in the corporate graph representing a professional represented by the item and a node in the corporate graph representing the user; and
select the recommended set of professionals from the candidate set of professionals based on the respective relevance values.

13. The system of claim 12, wherein the recommendation generator is to generate a relevance value from the respective relevance values for an item in the candidate set of professionals using a significance value associated with a pair comprising a member profile identification from the item and a skill from the item.

14. The system of claim 11, wherein the recommendation generator is to determine that the editing session is associated with a user represented by a user member profile in an on-line social network system, the user member profile including a set of user skills, wherein the recommended set of professionals is personalized based on the set of user skills.

15. The system of claim 14, wherein the recommendation generator is to:
generate a candidate set of skills that includes those entries from the set of skills that are omitted from the set of user skills; and
interrogate the inverted index of skill to person mappings using the candidate set of skills to retrieve items to be included in the recommended set of professionals.

16. The system of claim 14, wherein each skill from the set of user skills is assigned a respective significance score, the recommendation generator is to:
generate a personalized importance score for each skill in the set of skills using the respective significance scores;
generate a preliminary set of professionals by interrogating the inverted index of employees skills to retrieve items that include a skill from the set of skills;
generate respective relevance values for items in the preliminary set of professionals using the respective significance scores; and
based on the respective relevance values, select items from the preliminary set of professionals to be included in the recommended set of professionals.

17. The system of claim 14, wherein the recommendation generator is to generate a user set of professionals by interrogating the inverted index with a set of user skills to retrieve items that include a skill from the set of skills, the recommended set of professionals includes only items that are not present in the user set of professionals.

18. The system of claim 11, wherein the set of skills is associated with a section from a plurality of sections in the electronic presentation.

19. The system of claim 11, wherein the set of skills is associated with the entire electronic presentation.

20. A machine-readable non-transitory storage medium having instruction data executable by a machine to cause the machine to perform operations comprising:
detecting an editing session with respect to an electronic presentation, the editing session commenced at a computer system associated with a company identification, the company identification representing a company, the electronic presentation associated with a set of skills;
maintaining an inverted index of skill to person mappings associated with the company identification, an entry in the inverted index of skill to person mappings comprising a skill mapped to a member profile representing, in the on-line social network system, a person professionally engaged with the company, the skill corresponding to an entry in a skills database maintained in the on-line social network system;
accessing a corporate graph associated with the company identification, nodes in the corporate graph representing persons professionally engaged with the company;
generating a recommended set of professionals, each item in the recommended set of professionals comprising a reference to a person represented by a node in the corporate graph and associated with a skill from the inverted index of skill to person mappings; and
causing presentation, on a display device, of a reference to an item from the recommended set of professionals.
